(19) United States
(12) Patent Application Publication
(10) Pub. No.: US 2025/0264249 A1
(43) Pub. Date: Aug. 21, 2025

(54) MODULAR- SEQUENTIAL- HIGH-TEMPERATURE HEAT COLLECTION AND STORAGE DEVICE WITH INTEGRATED POWER CONVERSION UNIT

(71) Applicant: Exowatt, Inc., Miami, FL (US)

(72) Inventors: Sushrut BAPAT, Miami, FL (US); Pedro NEVES, Miami, FL (US); Kiran KAMBLY, Miami, FL (US); Ehsan ORDOUIE, Miami, FL (US); Hannan PARVIZIAN, Miami, FL (US); John M DELAPPE, Miami, FL (US)

(21) Appl. No.: 19/055,495

(22) Filed: Feb. 17, 2025

Related U.S. Application Data
(60) Provisional application No. 63/555,010, filed on Feb. 17, 2024.

(51) Int. Cl. F24S 20/20; F24S 20/00; F24S 23/30; F24S 30/425; F24S 60/00; F24S 80/00; F24S 80/45

(52) U.S. Cl. CPC F24S 20/20; F24S 23/31; F24S 30/425; F24S 60/00; F24S 80/45; F24S 2020/12; F24S 2020/13; F24S 2020/23; F24S 2080/017

(57) ABSTRACT

A modular-sequential-high-temperature heat collection and storage device with integrated power conversion unit.

### CROSS-REFERENCES TO RELATED APPLICATIONS

This application claims benefit of U.S. Provisional Patent Application No. 63/555,010 filed Feb. 17, 2024, which is incorporated herein by reference in its entirety and for all purposes.

This application is related to application Ser. No. 18/900,313 filed Sep. 27, 2024 incorporated herein by reference for all purposes as if expressly set forth herein:

### STATEMENT REGARDING FEDERALLY SPONSORED RESEARCH OR DEVELOPMENT

None.

### FIELD

The technology herein relates to heat collection, and more particularly to a modular-sequential-high-temperature heat collection and storage device with integrated power conversion unit.

### BACKGROUND AND SUMMARY

Renewable energy availability is intermittent which will hinder the transition towards a more sustainable energy infrastructure. The technology herein provides a power generation system and storage device that is fueled by the sun and operated by air or other thermal transfer fluid.

### BRIEF DESCRIPTION OF THE DRAWINGS

These and other features and advantages will be better and more completely understood by referring to the following detailed description of exemplary non-limiting illustrative embodiments in conjunction with the drawings, of which:

FIG. 1 is a schematic diagram of an overall system architecture.

FIGS. 2A-2C show different views of an example solar collection module.

FIG. 3 shows an example linear actuator detail.

FIG. 4 shows an example rail system detail.

FIGS. 5A-5C show an example module internal view revealing a thermal battery, power converter and continuous linear heat absorber.

FIGS. 6A-6B show different views of another embodiment of a solar collection module providing single axis rotation tracking of a lens array.

FIG. 7 shows an example continuous absorber design.

FIGS. 7A-7D show an example flip chart animation.

FIG. 8 shows how example Fresnel lens panels in the lens array have different focal points on the continuous absorber.

FIG. 9 shows an example lens array rotatable about a single axis.

FIG. 9A shows an example prior art slew ring bearing.

FIG. 10A shows an example charge loop.

FIG. 10B shows an example discharge loop.

FIG. 10C shows an example discharge loop detail to a Stirling engine.

FIG. 11 shows an example modular, scaleable thermal storage.

FIG. 11A shows an example modular thermal storage without an outside casing, housing or enclosure.

FIGS. 12A, 12B show different views of an example end detail of the thermal storage.

FIGS. 13A, 13B how an alternative design using discrete heat absorbers.

FIG. 14 shows an example side view.

FIGS. 15A and 15B show a first Load Balancing Solar-Thermal System with a power grid connection.

FIGS. 16A and 16B show a second Load Balancing Solar-Thermal System with a power grid connection.

### DETAILED DESCRIPTION OF EXAMPLE NON-LIMITING EMBODIMENTS

Example embodiments provide a high temperature heat collection device, a baseload electricity production system, and a dispatchable heat and electricity system. The system provides modular, sequential heat-collection, high-temperature storage, inline heat collection, and power conversion.

An example embodiment comprises a first solar absorber surface or portion that raises the temperature of a medium to a first temperature, a second solar absorber surface or portion raising the temperature of the medium from the first temperature to a second temperature, an Nth solar absorber surface or portion further raising the temperature of the medium; and a thermal load thermally coupled to the medium having the further raised temperature, the thermal load using heat provided by the medium. N can be any non-negative integer. The thermal load may comprise a Stirling engine and/or a thermal storage or any other thermal load.

### Example Overall System Architecture

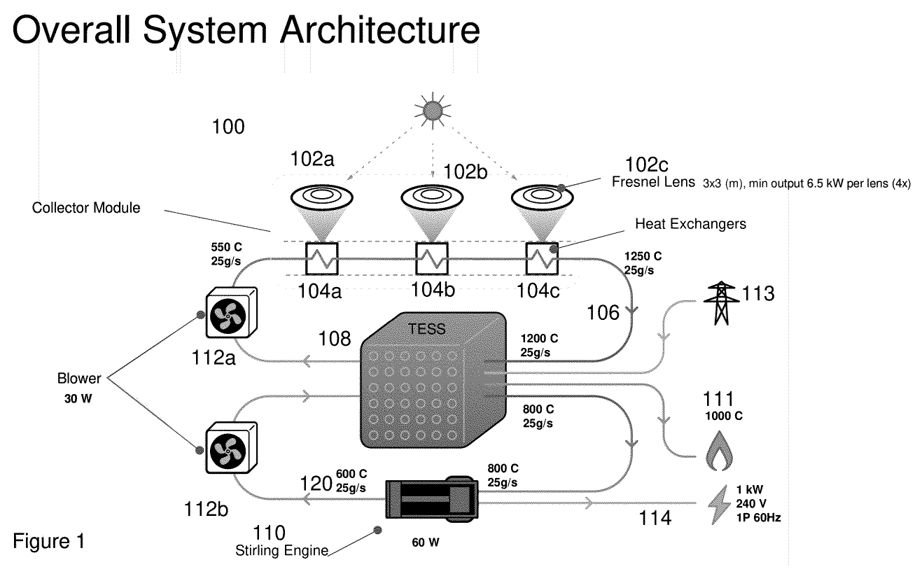

FIG. 1 shows an example embodiment of an overall embodiment system architecture of a sequential heat-collection system design 100. System 100 utilizes a combination of one or several heat collection stages each comprising a Fresnel lense 102 and an associated heat absorber 104. The sequential heat collection stage collects high-temperature heat. In particular, solar energy incident on each Fresnel lens 102 is concentrated on an associated absorber 104 or portion thereof. In one embodiment, the absorber 104 consists of or comprises an insulated-multi-channel heat exchanger that transfers this concentrated heat to transfer fluid that flows through the system's ductwork 106. The transfer fluid flowing through ductwork 106 and a blower 112a carries and delivers the heat to a thermal energy storage system (“TESS”) 108, where it can be stored for long duration periods.

In the example shown, a first Fresnel lens 102a collects heat and focuses the heat on an absorber 104a or portion thereof to raise the temperature of heat transfer fluid flowing within the absorber to a first temperature. A second Fresnel lens 102b collects heat and focuses the heat on an absorber 104b or portion thereof to raise the temperature of heat transfer fluid flowing within the absorber to a second temperature higher than the first temperature. A third Fresnel lens 102c collects heat and focuses the heat on an absorber 104c or portion thereof to raise the temperature of heat transfer fluid flowing within that absorber to a third temperature higher than the second temperature. In this way, a succession or sequence of heat collection stages can be used to successively increase the temperature of the heat transfer fluid to a very high temperature such as 1250 degrees Centigrade or higher as one example, for input into and storage by the TESS 108. As many heat collection stages as needed may be provided to raise the heat transfer fluid temperature to a desired temperature taking angle of sunlight/time of year, cloud cover and other factors into account.

Although FIG. 1 shows three Fresnel lens/absorber 102/104 modules to provide three sequential heat collection stages, there can be any number of such combinations such as one Fresnel lens/absorber 102/104, two Fresnel lens/absorbers 102/104, three Fresnel lens/absorbers 102/104, four Fresnel lens/absorbers 102/104, five Fresnel lens/absorbers 102/104, six Fresnel lens/absorbers 102/104, or N Fresnel lens/absorbers 102/104 where N is any positive integer. In the example shown, the thermal fluid flows through the three Fresnel lens/absorbers units 102/104 in series, but in other embodiments the thermal fluid can flow through such units in parallel, or some of the thermal fluid can flow through two or more such units in series whereas other thermal fluid can flow through such units in parallel to provide a series-parallel combination. The number of such Fresnel lens/absorbers 102/104 can be determined by the power output required. In the example shown, the configuration is 3×3 (m) with a minimum output of 6.5 kW per lens (4×) but other configurations are possible depending on particular requirements.

In one embodiment, the thermal collectors 102/104 provide a modular arrangement where each heat collection stage comprises or provides a module. In such embodiments, it is possible to swap out or interchange one module for another, to add modules or to subtract modules.

While the absorber 104 shown is represented by separate heat absorber blocks 104a, 104b, 104c, the dotted lines surrounding these blocks indicate the absorber in some embodiments can be a common or unified or extended structure that receives a sequence or succession of thermal energy focal points from multiple Fresnel lenses in a lens array Such a design is described in detail below. In other embodiments, the absorbers 104a, 104b, 104c may comprise separate and distinct heat absorber structures that are coupled together by a flow of thermal transport fluid such as ducts.

In one embodiment, the thermal fluid charge circuit passing through the heat exchangers 104 delivers collected heat to thermal energy storage system (TESS) 108. The heat stored in the thermal energy storage system 108 can then be dispatched via a separate, thermal fluid discharge circuit to a power conversion system 110 and/or dispatched as high quality temperature (e.g., 1000 degrees C.) heat 111 for a variety of industrial applications. Also shown in FIG. 1 is an electrical input 113 from the power grid that can be used to generate heat (e.g., through conventional resistive heating elements) to heat the TESS 108 when heat from the sun is inadequate.

After the power conversion system 110 converts heat to electricity, the remaining heat in the heat transfer fluid exits the power conversion system with a lower temperature at 120 and is circulated back to the TESS 108 for the next cycle. One or more blowers or pumps 112 may be used to provide such recirculation. In particular, the output of blower 120b shown can be directed to either the TESS 108 or to the chain of thermal collectors 102/104 or both, but in the example embodiment shown there are two different recirculation circuits—a heat input circuit to recirculate input heat to the TESS 108, and an output circuit to recirculate heat outputted or drawn from the TESS.

As detailed below, in one embodiment, the thermal energy storage system 108 contains insulated thermal energy blocks that are arranged in series/parallel configuration to store the energy required for off-sun hours of system operation. The sequential nature of heat collection allows the system to be scalable for any power conversion unit capacity. The system is extremely flexible in layout and modular for ease of integration and installation.

In one embodiment, the power conversion system 110 comprises one or more Stirling engines that accept the heat from the incoming transfer fluid and convert it to electricity 114 and low(er)-temperature heat.

### Example Heat Collection Module

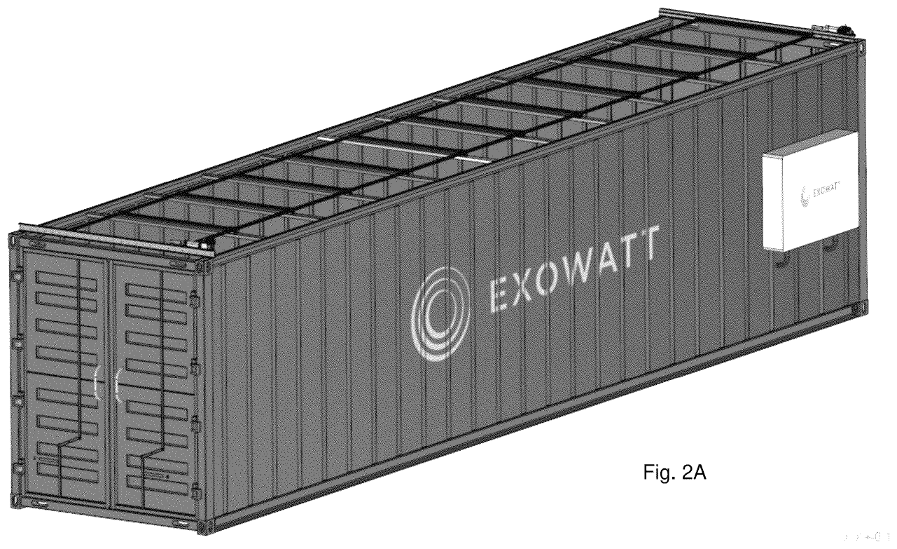

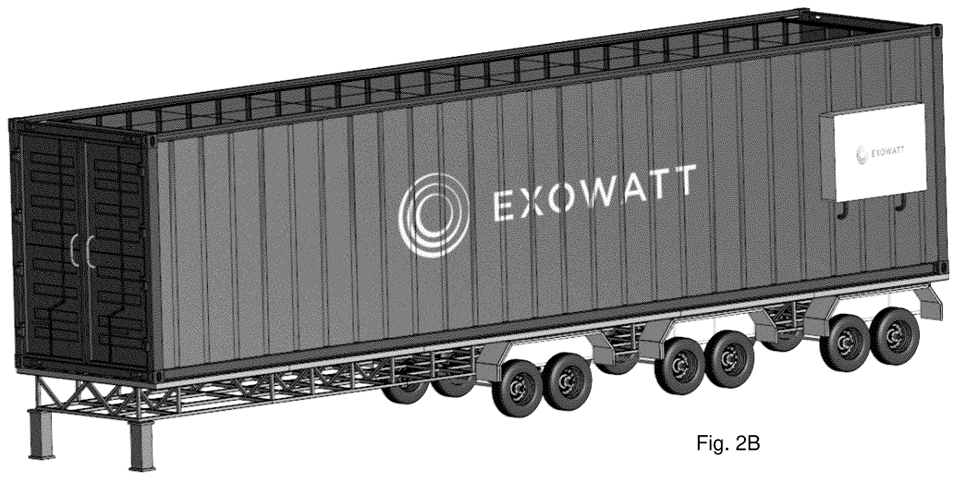

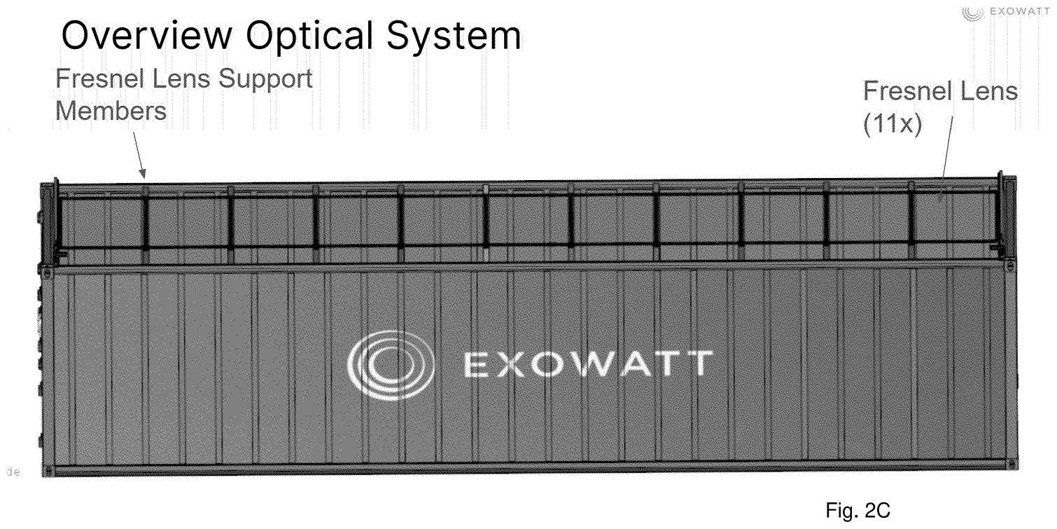

FIGS. 2A, 2B, 2C show an embodiment of an example heat collection module structured in the form factor of a steel container such as an ISO “intermodal” shipping container of the type that can be carried by a tractor-trailer, a ship, or a train. The module enclosure may have a standard size of 8 feet (2.44 m) wide, and of either 20 or 40 feet (6.10 or 12.19 m) standard length, as defined by International Organization for Standardization (ISO) standard 668:2020. The enclosure may be rectangular with a bottom, two long sides and two ends. In one embodiment, each enclosure can contain a complete solar collection module or stage as described above. The modular enclosures can be transported on wheels as shown in FIG. 2B using an undercarriage structure having multiple axles. Containers can be positioned end to end to construct a multi-stage and/or multi-module solar collection system if desired. The module enclosure shown can contain all of the components shown in FIG. 1.

In one example shown, the top of the enclosure is open and supports crossbeams that in turn support a linear array of Fresnel lens panels as shown in FIG. 2A, 2C. There can be many Fresnel lens panels (e.g., 11 panels as shown in FIG. 2C) structured in a linear array that runs longitudinally along the length of the enclosure.

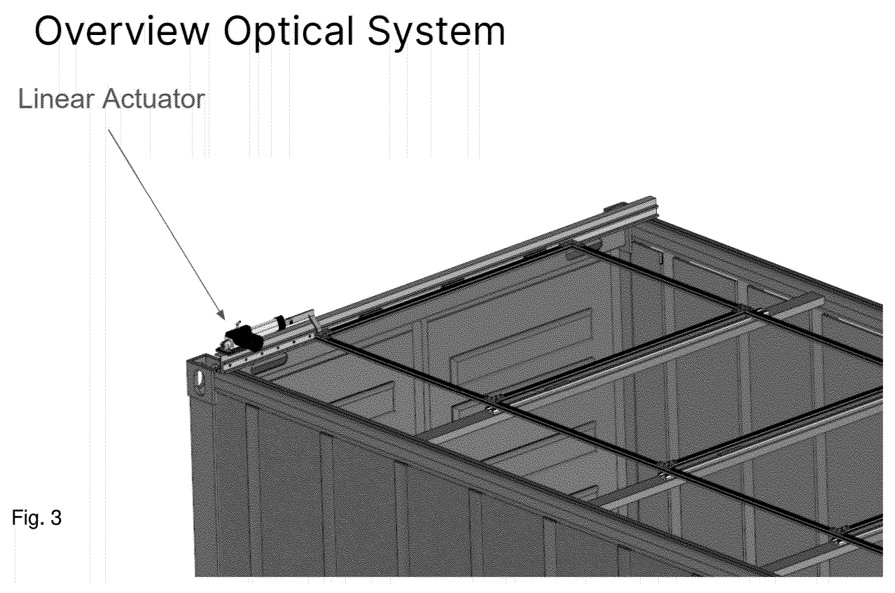

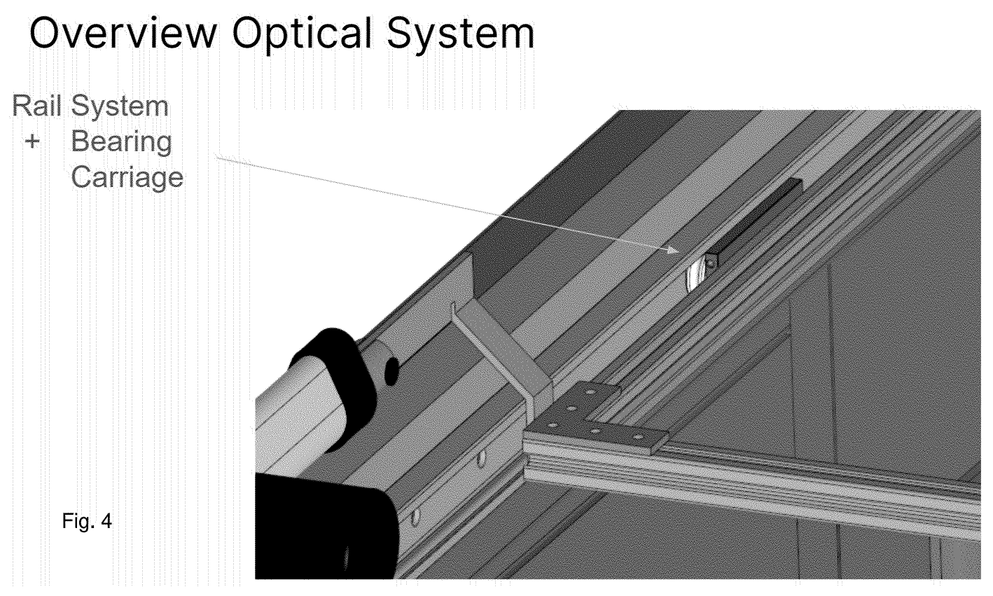

In one embodiment shown in FIG. 3, one or more linear actuators are used to adjust the position and/or orientation of the Fresnel lens panels in order to track the changing position of the sun. As shown in FIG. 4, the lens panels can be supported on a rail system including a bearing carriage to enable the linear actuator to adjust the position of the lens panel.

### Internal Structure of a Solar Collection Module

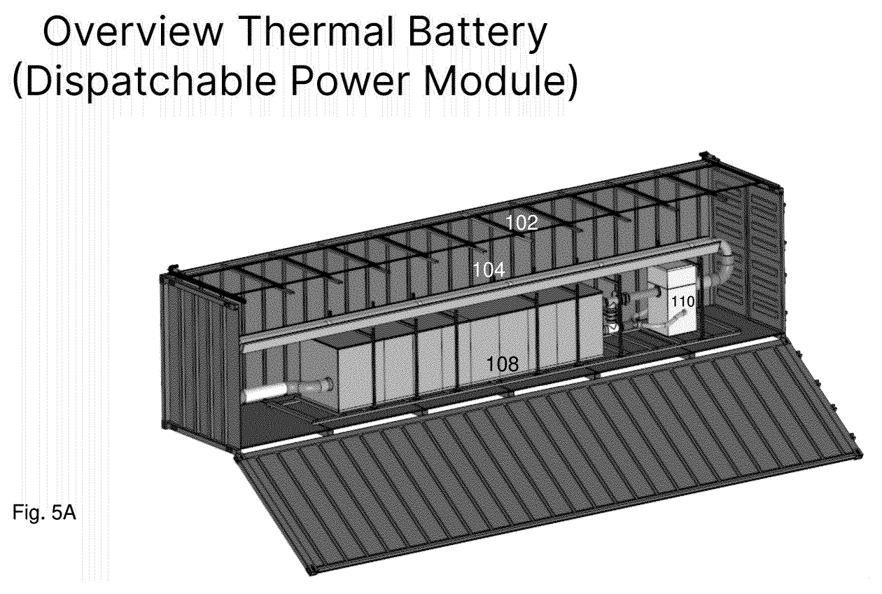

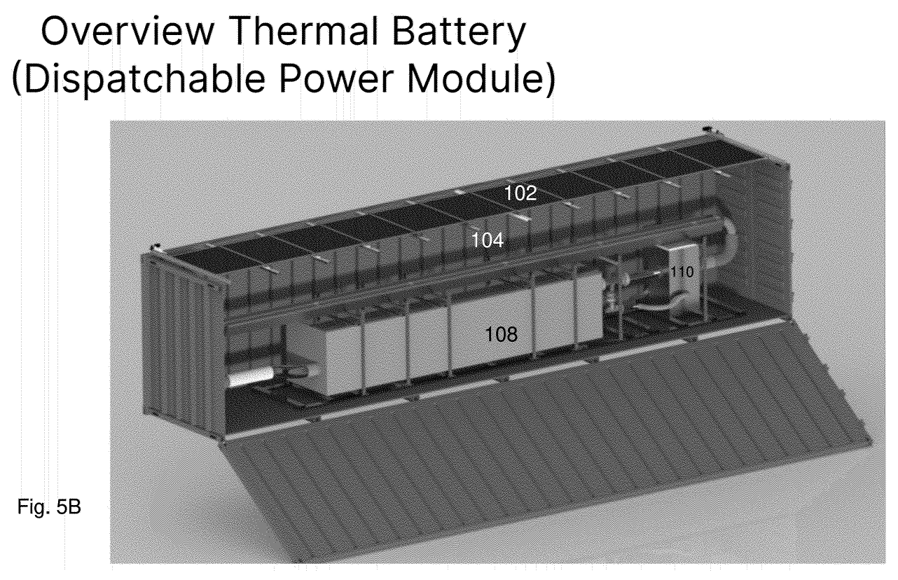

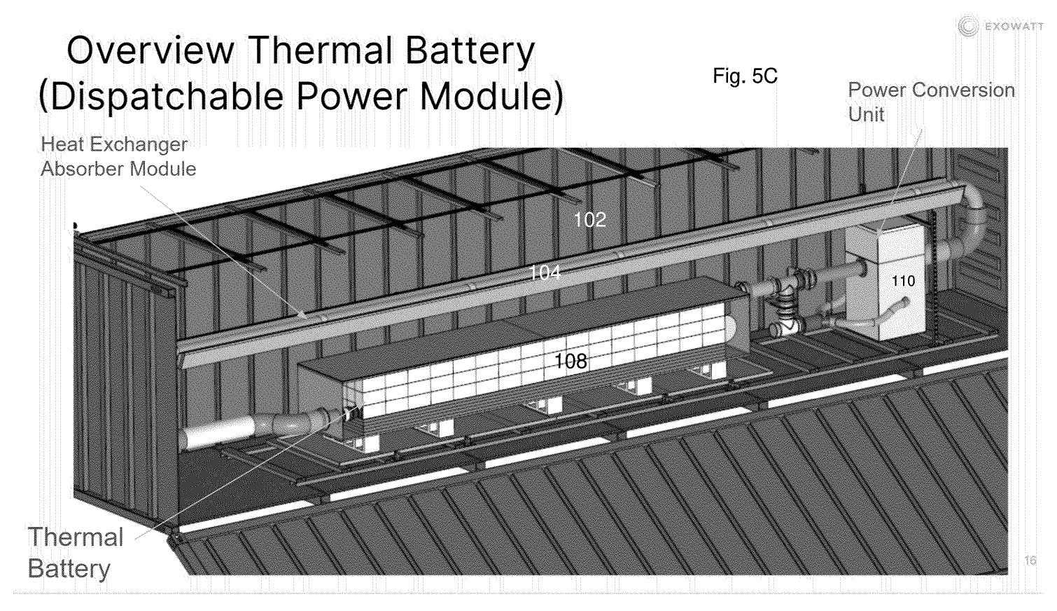

FIG. 5A-5C show example internal details of a module including a TESS 108, a power converter 110 and a linear heat exchanger 104. The linear heat exchanger 104 receives solar energy from the array of Fresnel lenses 102 thus providing a continuously-staged heat exchange system. The linear heat exchanger 104 provides the generated thermal energy to the TESS 108 which in this embodiment can be a ectangular block of clay or other heat retention material. The power converter 110 such as a Stirling engine can produce electricity and/or mechanical power from the stored heat the TESS 108 provides.

### Single Axis Tracking Embodiment

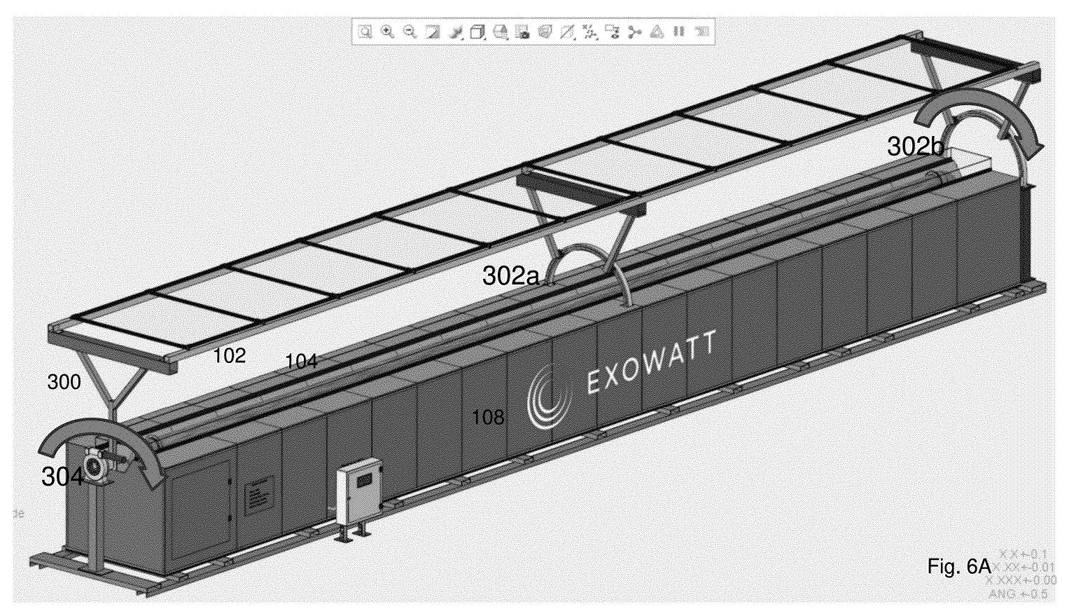

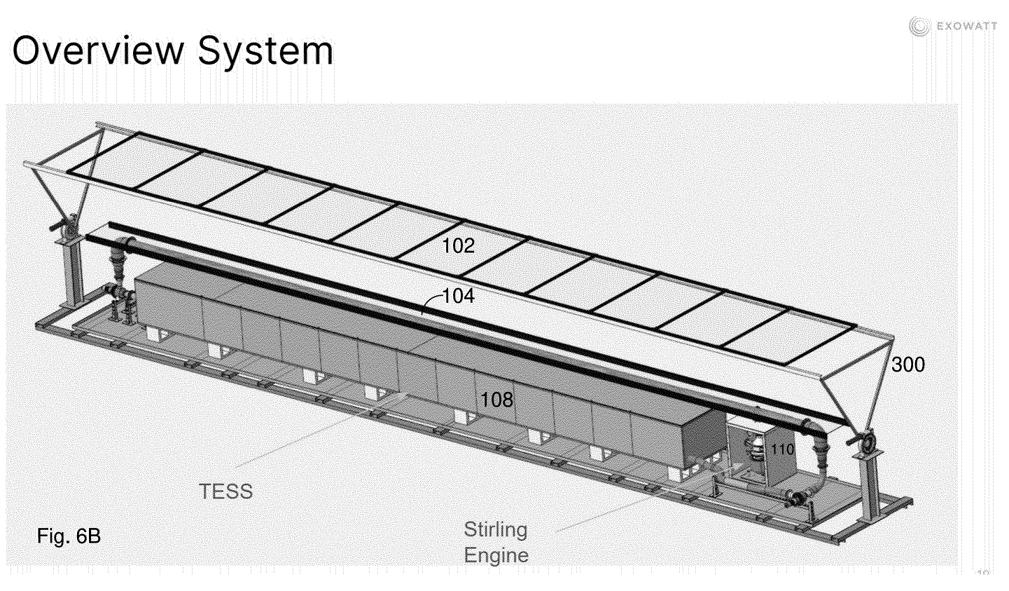

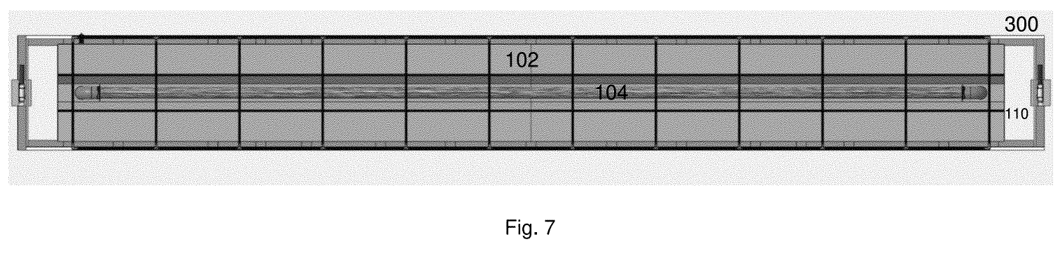

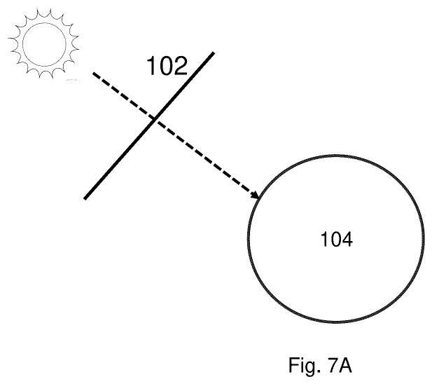

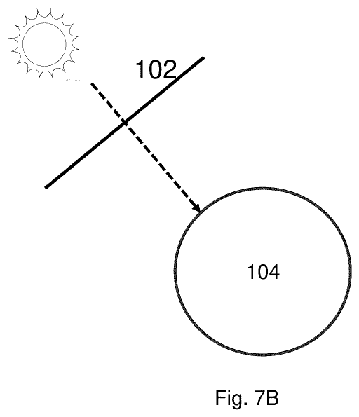

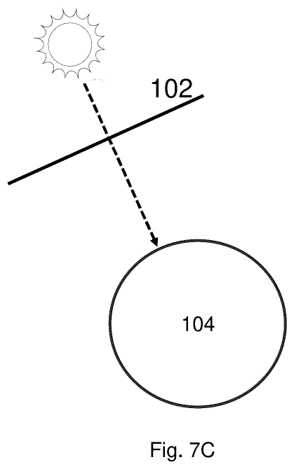

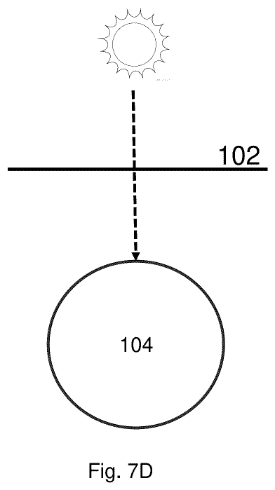

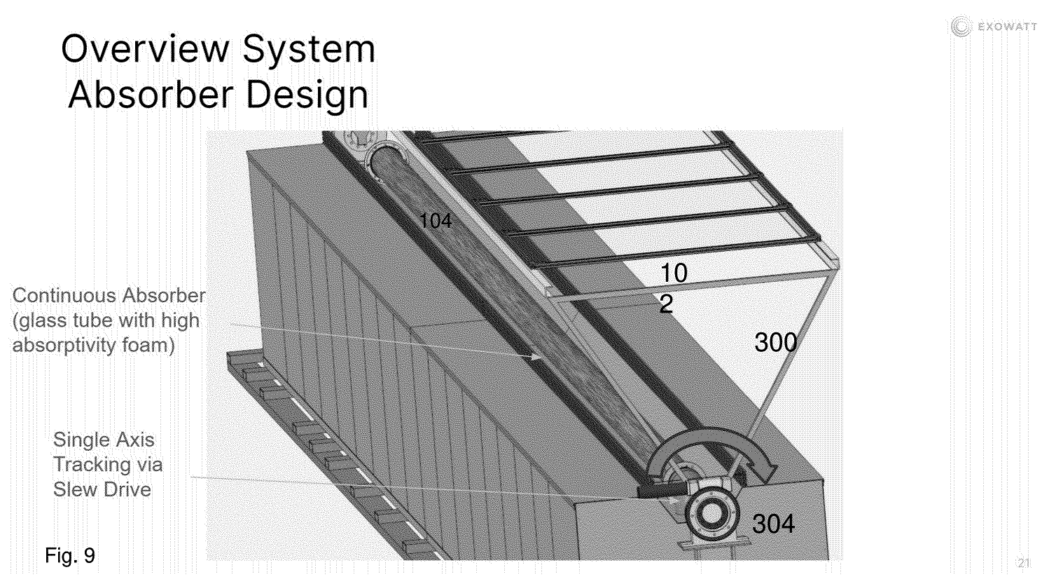

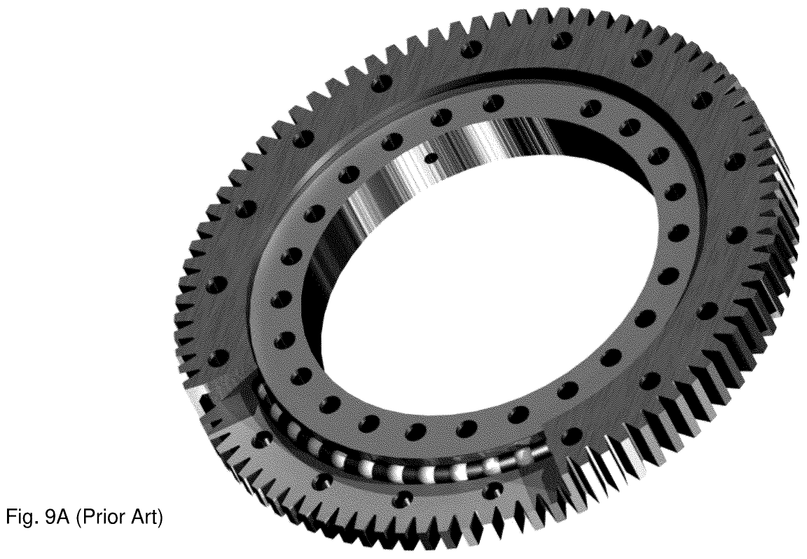

FIGS. 6A-6B show another embodiment that supports the Fresnel lens array 102 on a frame 300 that is rotatable about the longitudinal axis of the lens array. In the example shown, the frame 300 is supported by uprights to the frame 300 that enable the frame to rotate about a single axis longitudinal to the module. The module is oriented on the earth's surface relative to the sun so that the single axis of rotation can, using a slew drive based on conventional geared rotary slew ring bearings (see FIG. 7A for one example), track the position of the sun in the sky. This embodiment can also be provided in the form factor of an ISO container as shown in FIGS. 2A et seq with adjustments made to accommodate the swing of the rotating frame 300 projecting upward and away from the module's enclosure. In the FIG. 6A and FIG. 9 example, the frame 300 is rotatably supported by ring bearings 302a, 302b that enable the frame to rotate from −90 degrees relative to horizontal to horizontal to +90 degrees relative to horizontal. The slew ring bearing drive 304 (which may be driven by a conventional stepper or locking motor and controller) holds the frame 300 in position and changes the rotational position of the frame to thereby cause the lens array 102 to track the sun's position. The controller can cause the array to rotate to a resting/locking position at night or in the event of heavy weather.

### Example Linear Absorber

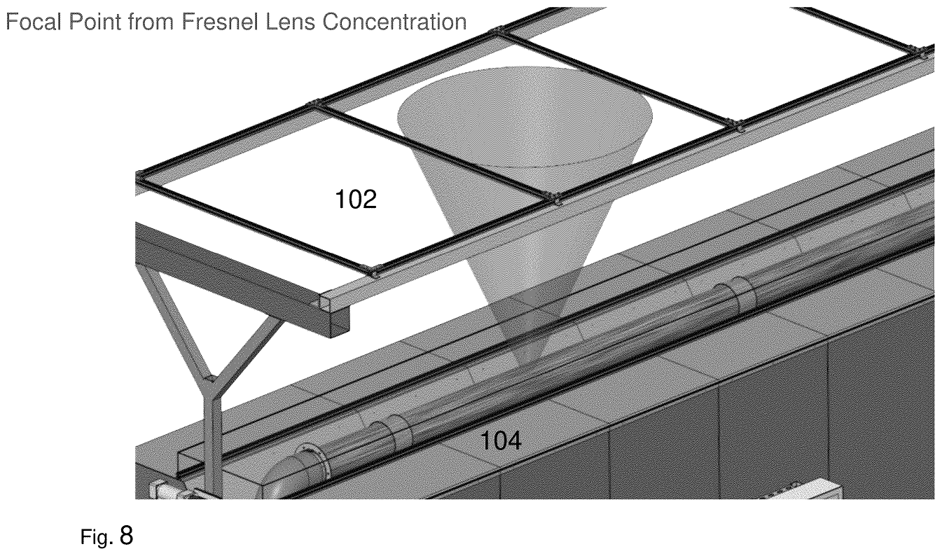

FIG. 7 shows an example detail of the continuous linear absorber 104. In this embodiment, linear absorber receives thermal energy from each (all) of the lenses in the lens array 102. Different ones of the lenses of array 102 focus thermal energy onto different corresponding portions of the linear absorber 104, as shown in FIG. 8. Thus, a first lens 102a can focus thermal energy onto a first linear absorber portion, a second lens 102b can focus thermal energy onto a second linear absorber portion, and so on.

In one embodiment, linear absorber 104 comprises a glass or quartz tube containing stainless steel foam with high thermal absorption. As the slew drive 304 rotates the Fresnel lens panel array to track the sun's position, the lenses continue to focus the solar energy onto other portions of the outer cylindrical surface of the continuous absorber 104 through which a heat transport fluid flows. See FIGS. 7A-7D which together are a flip chart animation of how the lens array may be rotated to track the sun's position as it rises in the sky, and how the lenses concentrate solar energy onto different portions of the absorber's cylindrical outer surface. The continuous absorber 104 in one embodiment comprises a hollow tubular structure or pipe comprising high-temperature glass, quartz, or other thermally transparent and/or light transmissive material that efficiently admits heat. The tube shape design provides more surface area (high absorptivity and high porosity), allowing it to absorb light more effectively at different angles due to its curved or cylindrical geometry. Inside the radiation-transmissive pipe is high-absorption foam or other material that absorbs the thermal energy. The radiation-transmissive pipe retains the thermal energy within the absorber structure. A flow of thermal transport fluid such as air or other gas continuously moves the thermal energy along and out of the linear absorber and transports it to a TESS 108 in one embodiment. The thermal fluid progressively gains heat as it flows from one absorber hot spot to another (see FIG. 8 which shows one hot spot—other lenses create other adjacent hot spots on the absorber's outer surface), each hot spot existing at a focal points of a corresponding Fresnel lens in the array 102 but rotating about the outer periphery of the absorber as the lens rotates to track the sun's position.

### Charge and Discharge Loops

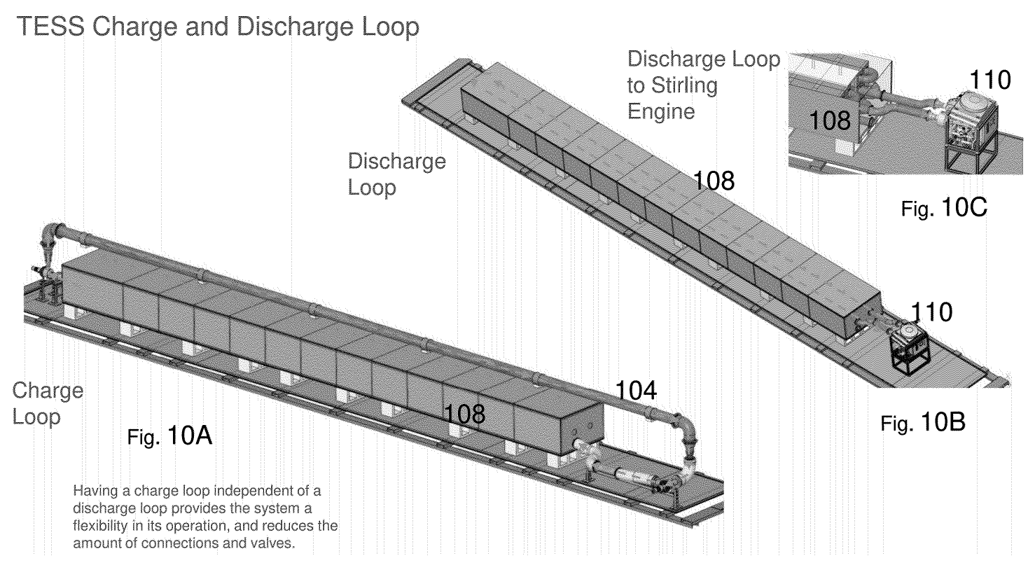

As shown in FIGS. 10A, 10B, 10C, the TESS may define at least two paths running through it: a charge path (FIG. 10A) and a discharge path (FIG. 10B). The charge path defines a charge loop that recirculates the thermal fluid through the linear absorber so heat from the absorber is used to heat the TESS. Control precautions are taken so overheating does not occur. The discharge loop shown in FIG. 10B meanwhile circulates thermal transport fluid along and through the length of the TESS 108 to deliver and output heat to the Stirling engine 110 or other thermal load. After energy is produced the remaining exhausted heat will be recirculated through the discharge loop and back into the TESS to be then recirculated.

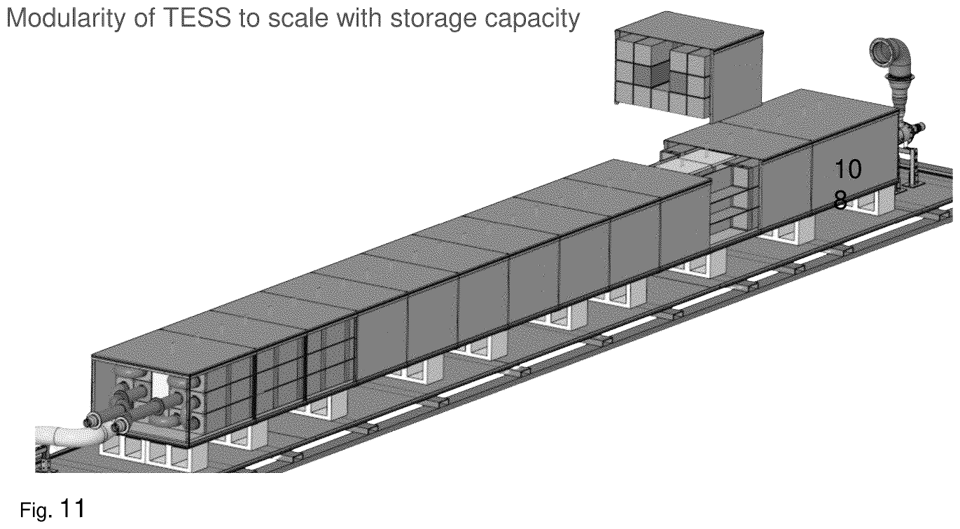

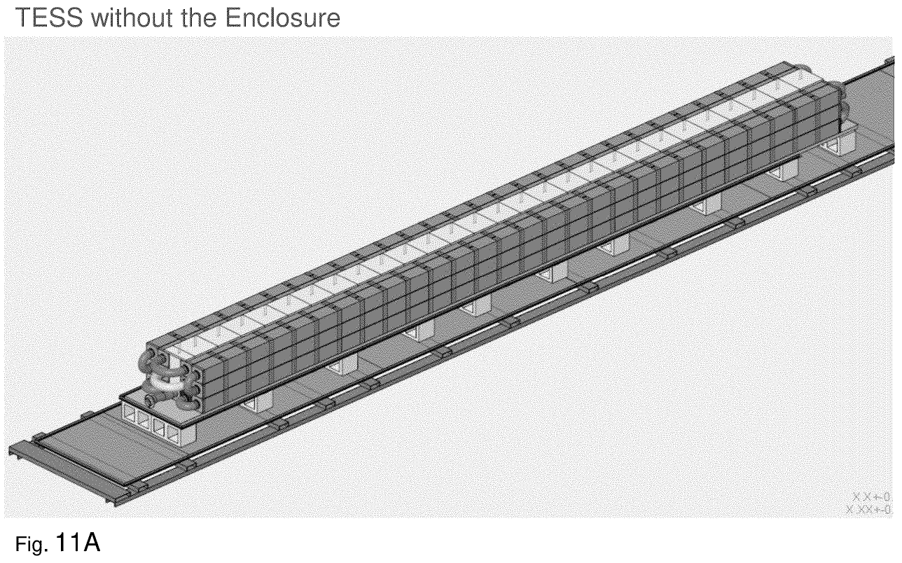

FIG. 11 shows an embodiment of TESS 108 comprising a plurality of modules. The TESS 108 can be expanded by adding modules or contracted by removing modules in order to change the heat retention capacity of the TESS. Different installations of TESS 108 can thus be customized to provide more or less heat storage capacity as needed.

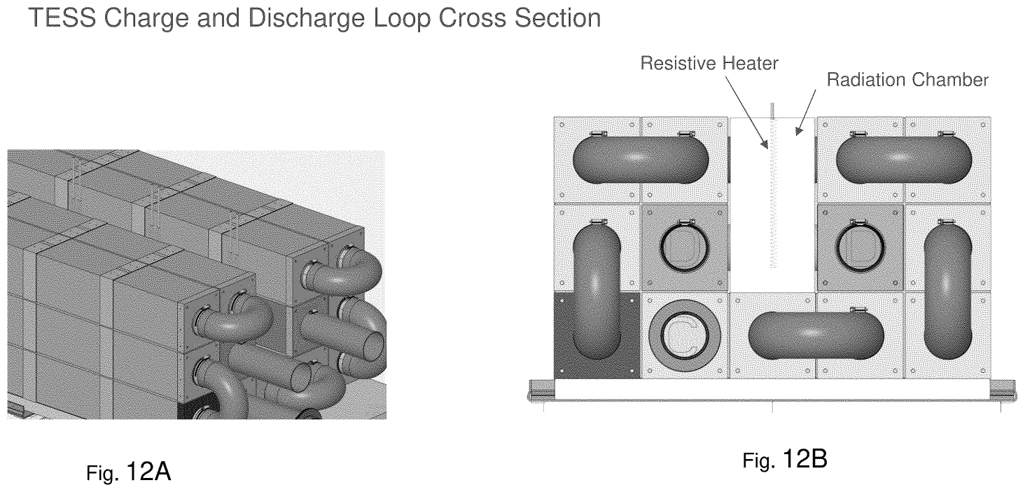

FIG. 11A shows the TESS 108 with its housing removed. In this example embodiment, TESS 108 comprises stacks of individual blocks or cakes of clay or other heat retaining material. The clay blocks have passages defined there through to enable heat transport fluid to flow from block to block along the length of the TESS 108. The example shown comprises a stack of blocks three blocks high and four blocks across with a gap in the center forming a radiation chamber for a resistive heater. See FIG. 12B end view. As noted above, the resistive heating element can be powered with electricity from the grid to heat the TESS 108 when solar energy is not available. As FIGS. 12A, 12B show, end piping can be used to enable thermal transport fluid to flow back and forth through passages internal to the TESS from one end of the TESS 108 to the other. As noted above, different passages can be used for heat input and heat discharge. In the embodiment shown, the heat discharge flow originates and terminates at the same end of the TESS 108, whereas the heat input flow originates at one end of the TESS and terminates and the other end of the TESS.

### Further Thermal Collection Module Embodiment

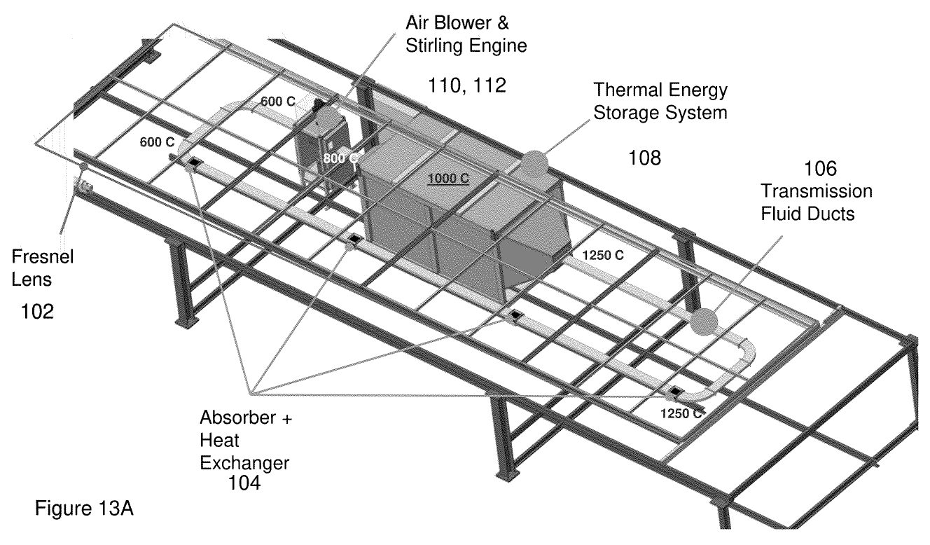

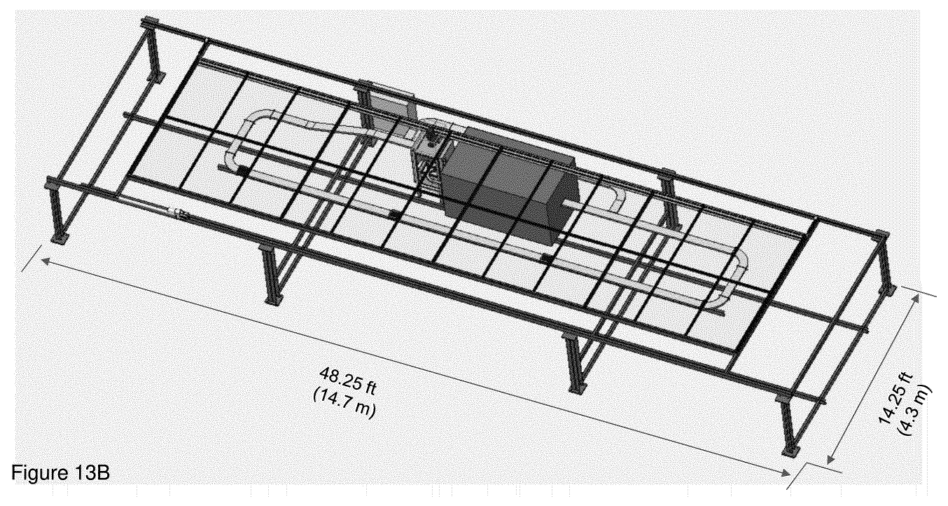

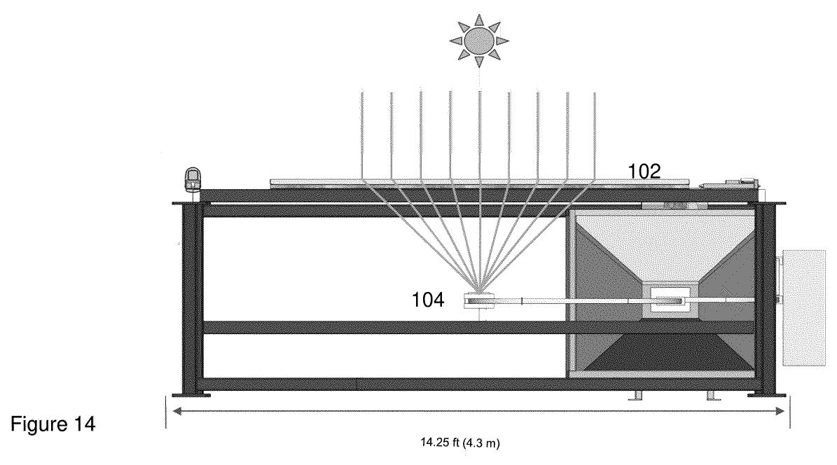

FIGS. 13A, 13B and 14 show another embodiment of an example thermal collection module comprising a collector lens 102, associated heat absorbers 104 and associated support structure. In the FIG. 2 example shown, the Fresnel lenses 102 are represented by a single large planar panel. However, in actual embodiments, this large panel may comprise a number of individual Fresnel lenses 102 each having a corresponding focal point onto an associated heat absorber 104. Or in some embodiments, a single panel structure may be configured to provide multiple Fresnel lenses each having an associated focal point.

In one embodiment, as described above for the FIG. 2A et seq embodiment, the construction of the FIG. 13A, 13B, 14 design is configured to fit into a standard container of the type that can be pulled by a tractor-trailer, placed on a train or ship, etc. Each module can operate separately and independently, or any number of such modules can be connected together to form a progressive heating system as shown in FIG. 1 where a first module raises the temperature of a heat transport medium to a first temperature, a second module further raises the temperature of the heat transport medium to a second temperature higher than the first temperature, a third module further raises the temperature of the heat transport medium to a third temperature higher than the second temperature, etc.

FIG. 14 shows a side view of the FIG. 2 example module showing a Fresnel lens 102 focusing energy from the sun onto an associated discrete absorber/heat exchanger 104.

### Additional Heat Exchanger Embodiment-Power Grid Connection

An additional example embodiment herein provides a heat exchanger that generates and stores heat from the electric power grid to supplement heat collected from the sun. In one example embodiment, the system converts to heat for use and/or storage, excess electricity produced by or available on the power grid when demand is low and electricity is thus less expensive. A Grid-Balancing Solar-Thermal System contains a conventional solar-thermal system coupled with electric heaters to store excess electricity to heat, and electric Heaters are added to the TESS.

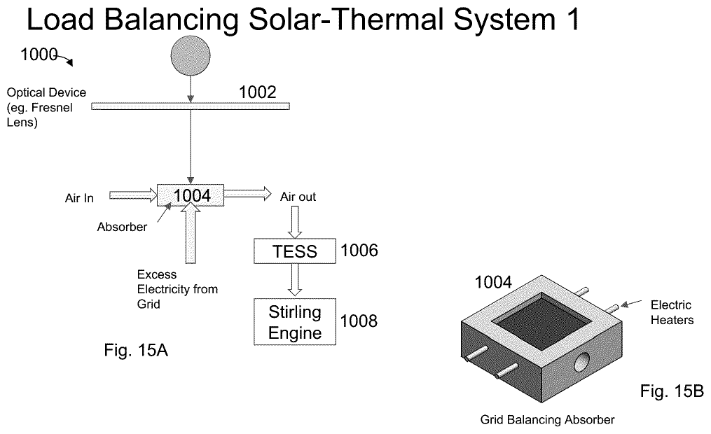

FIG. 15A shows an example solar thermal collection system 1000 including an optical device 1002 such as a Fresnel lens that collects thermal energy from the sun and focuses the collected thermal energy onto an absorber 1004. A circulation system (which can use air or some other gaseous or liquid medium for heat transport) circulates the collected heat from the absorber to a thermal storage system (TESS) 1006. The TESS supplies the stored heat to a load such as a thermal engine 108.

In the example shown, the absorber 1004 has electric heating elements that are selectively connected to and disconnected from the electric power grid or other source of electric power. During periods when the electric power grid produces an excess of electricity (i.e., so that the cost of such electricity is reduced), the absorber's electric heating elements may convert electricity from the electric power grid to heat and supply the heat to the TESS 1006 for storage and eventual application to the thermal engine 108. Such storage of surplus energy in the form of heat balances loading of the electric power grid so the grid supplies power to system 1000 during times when demand is low. When demand from the electric power grid is high, system 1000 can disconnect the heating elements from the electrical grid and rely instead on heat that had previously been stored in the TESS 1006 by the electric heaters and/or based on current solar collection. Such a grid-balancing solar-thermal system 1000 contains a conventional solar-thermal system coupled with electric heaters to store excess electricity to heat.

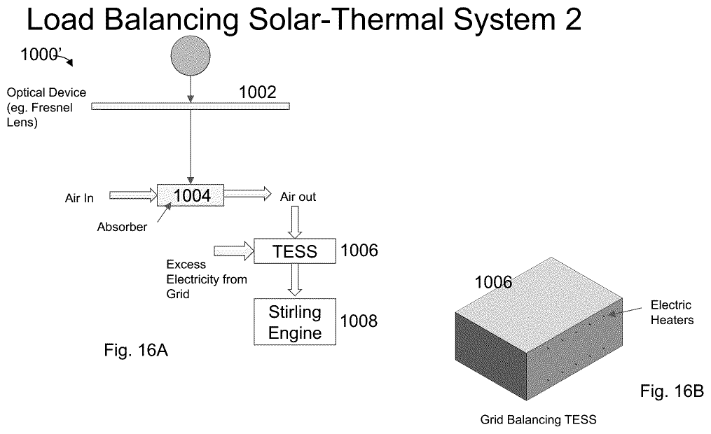

FIGS. 16A and 16B shows a second embodiment of a load balancing solar thermal collection system 1000′ where the TESS 1006 has electric heating elements to convert electricity from the electric power grid to heat for storing within the TESS. A grid-balancing solar-thermal system thus contains a conventional solar-thermal system coupled with electric heaters in the TESS to store excess electricity to heat.

In one embodiment, an electrical energy monitor (not shown) and an automatic transfer switch can be used to selectively connect the heating elements to the power grid and disconnect the heating elements from the power grid. See e.g., Jiang et al, “Smart grid load balancing techniques via simultaneous switch/tie-line/wire configurations,” 2014 IEEE/ACM International Conference on Computer-Aided Design (ICCAD), San Jose, CA, USA, 2014, pp. 382-388, doi: 10.1109/ICCAD.2014.7001380. Such calculations can be performed by at least one processor connected to non-transitory memory, the processor being configured to execute software instructions and/or perform hardware based algorithms to detect or otherwise determine or predict loading of the power grid.

All patents and publications cited above are incorporated by reference.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

We claim:

1. A system comprising:
a first solar collection stage that raises the temperature of a medium to a first temperature,
a second solar collection stage raising the temperature of the medium from the first temperature to a second temperature,
an Nth solar collection stage further raising the temperature of the medium; and
a thermal load thermally coupled to the medium having the further raised temperature, the thermal load using heat provided by the medium.

2. The system of claim 1 wherein the thermal load comprises a Stirling engine.

3. The system of claim 1 wherein the thermal load comprises a thermal storage.

4. The system of claim 1 wherein the first and second stages are modular.

5. The system of claim 1 wherein the first and second stages operate using different portions of a continuous heat absorber.

6. The system of claim 1 wherein the system is disposed in an intermodal shipping container form factor.

7. A thermal collection system comprising:
a thermal storage;
a Stirling engine
a lens array rotatable about a longitudinal axis of the thermal storage; and a linear heat absorber disposed along the longitudinal axis of the thermal storage, the linear heat absorber receiving concentrated thermal energy from the lens array on different portions along its length from different lenses in the lens array, the linear heat absorber receiving concentrated thermal energy from the lens array on different portions of its periphery as the lens array rotates about the longitudinal axis.

8. The thermal collection system of claim 7 wherein the thermal storage is modular.

9. The thermal collection system of claim 8 wherein the modules comprise clay blocks.
